(19) United States
(12) Patent Application Publication
(10) Pub. No.: US 2026/0205291 A1
(43) Pub. Date: Jul. 16, 2026

(54) MULTI-ENTITY AUTHENTICATION OR AUTHORIZATION

(71) Applicant: Nokia Solutions and Networks Oy, Espoo (FI)

(72) Inventors: Siddharth Prakash RAO, Espoo (FI); Alexandros BAKAS, Espoo (FI)

(21) Appl. No.: 19/433,318

(22) Filed: Dec. 26, 2025

(30) Foreign Application Priority Data
Jan. 10, 2025 (FI) 20255012

(51) Int. Cl. H04L 9/32

(52) U.S. Cl. CPC H04L 9/321

(57) ABSTRACT

One method provided comprises receiving a request to authenticate or authorize a requestor; receiving, from each of plural devices, a respective masked weighted private key and a respective encrypted vote, wherein, for each of the devices, the respective weighted private key is a private key of the respective device weighted with a respective weight; calculating a functional decryption key based on a sum of the masked weighted private keys; computing a sum of weighted votes of the devices by a decryption algorithm using the functional decryption key and the encrypted votes, wherein, for each of the devices, the respective weighted vote is the vote from the respective device weighted with the respective weight; checking if the sum of the weighted votes fulfills a comparison criterion with respect to a threshold; inhibiting to authenticate or authorize the requestor if the sum of the weighted votes does not fulfill the comparison criterion.

### TECHNICAL FIELD

The present disclosure relates to multi-entity authentication or authorization.

### Abbreviations

3GPP 3^{rd} Generation Partnership Project
4G/5G/6G 4^{th}/5^{th}/6^{th} Generation
eSIM embedded SIM
eUICC embedded Universal Integrated Circuit Card
FE Functional Encryption
HSM Hardware Security Module
iSIM integrated SIM
MPC Multi-Party Computation
MUSA Multi-user Single Account
NFC Nearfield Communication
OS Operating System
RSP Remote SIM Provisioning
SIM Subscriber Identity Module
SUMD Single User Multiple Devices
SMS Short Message Service
TEE Trusted Execution Environment
TPM Trusted Platform Module

### BACKGROUND

Passwordless solutions employ device-specific cryptographic keys instead of a common, user-generated password to authenticate the user or authorize the user for a service (hereinafter: “authenticate/authorize”). There are several security advantages of such an approach.

A recent trend in user authentication/authorization is to use asymmetric cryptographic solutions instead of human-generated passwords. In the so-called “passwordless authentication”, a public and private key pair is generated on the user's device, where the public key is distributed, and the private key remains securely stored on the device. During user authentication, a login request from the service provider is signed on the device with the private key, which the service provider can verify using the user's public key. The key generation is based on the WebAuthentication standard. A main advantage is that the private keys are immune to guessing and brute-force attacks compared to human-generated passwords.

There are two widely used approaches for storing the keys. In the first approach, one key pair is generated for each device for a given service the user has to authenticate/authorize. Thus, a single service will have N unique keypairs if the user has N devices. The private keys are stored on the operating system (OS) specific credential storage software and never leave the device. In the second approach, one key pair is generated for each service, and that key will be synchronized across all the user devices. In other words, the user will be using the same key from all N devices to authenticate/authorize the service. The private keys are stored on the operating system (OS) specific credential storage software and does leave the device during synchronization. The private keys may also be stored on the cloud. However, the storage is end-to-end encrypted with separate brute-force resilient keys known only to the user but not to the cloud provider. In both approaches, the private keys stored on the user device are authorized using a screen lock mechanism such as a PIN, a pattern, or biometrics.

### SUMMARY

It is an object to improve the prior art.

According to a first aspect, there is provided an apparatus, comprising
first means for receiving a request to authenticate or authorize a requestor;
second means for receiving, from each of plural devices, a respective masked weighted private key and, depending on a decryption algorithm, one of a respective encrypted vote or a value of a function of the respective encrypted vote and a weight for the respective device, wherein, for each of the plural devices, the respective weighted private key is a private key of the respective device weighted with the weight for the respective device;
means for calculating a functional decryption key based on a sum of the masked weighted private keys;
means for computing a sum of weighted votes of the plural devices by the decryption algorithm using the functional decryption key and the one of the encrypted votes from the plural devices or the values of the function of the encrypted vote and the weight from the plural devices, wherein, for each of the plural devices, the respective weighted vote is the vote from the respective device weighted with the weight for the respective device;
means for checking if the sum of the weighted votes fulfills a comparison criterion with respect to a threshold;
means for inhibiting to authenticate or authorize the requestor, respectively, if the sum of the weighted votes does not fulfill the comparison criterion with respect to the threshold.

The apparatus may further comprise
means for authenticating or authorizing the requestor, respectively, if the sum of the weighted votes fulfills the comparison criterion with respect to the threshold.

The first means for receiving may be configured to receive the request to authenticate or authorize the requestor, respectively, from one of the devices or from a further device different from each of the plural devices.

The apparatus may further comprise
means for triggering each of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is received; and
means for inhibiting the means for triggering from triggering any of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is not received.

The comparison criterion may be fulfilled if the sum of the weighted votes is larger than or equal to the threshold.

The comparison criterion may be fulfilled if the sum of the weighted votes is smaller than or equal to the threshold.

The apparatus may further comprise
third means for receiving a value of a sum of masking parameters; wherein
the means for calculating the functional decryption key may be configured to calculate the functional decryption key by adding the encrypted masked weighted private keys from the plural devices to obtain an intermediate sum and subtracting the value of the sum of the masking parameters from the intermediate sum.

The third means for receiving may be configured to receive the value of the sum of the masking parameters from a master device, wherein
the master device is one of the plural devices; or
the master device is not one of the plural devices.

The means for triggering may be configured to trigger the master device to provide the value of the sum of the masking parameters if the request to authenticate or authorize the requestor, respectively, is received; and
the means for inhibiting may be configured to inhibit the means for triggering from triggering the master device to provide the value of the sum of the masking parameters if the request to authenticate or authorize the requestor, respectively, is not received.

The third means for receiving may be configured to receive the value of the sum of the masking parameters from a user.

The means for calculating the functional decryption key may be configured to calculate the functional decryption key by adding the encrypted masked weighted private keys from the plural devices.

According to a second aspect, there is provided an apparatus, comprising
means for obtaining an effective masking parameter;
first means for generating a masked weighted private key based on a private key, the effective masking parameter, and a weight;
means for determining a vote for authenticating or authorizing a requestor;
means for encrypting the vote by a public key;
first means for providing the masked weighted private key and the encrypted vote to a deciding unit for deciding whether or not to authenticate or authorize the requestor, respectively, wherein
   the public key and the private key are a public/private key pair.

According to a third aspect, there is provided an apparatus, comprising
means for obtaining an effective masking parameter;
first means for generating a masked weighted private key based on a private key, the effective masking parameter, and a weight;
means for determining a vote for authenticating or authorizing a requestor;
means for encrypting the vote by a public key;
means for calculating a value of a function of the encrypted vote and the weight;
first means for providing the masked weighted private key and the value of the function of the encrypted vote and the weight to a deciding unit for deciding whether or not to authenticate or authorize the requestor, respectively, wherein
the public key and the private key are a public/private key pair.

For the apparatus according to any of the second and third aspects, one or more of the following may apply:

The weight may be preconfigured.

The apparatus may further comprise means for receiving the weight.

The first means for generating the masked weighted private key may be configured to generate the masked weighted private key by weighting the private key with the weight and adding the obtained effective masking parameter to the weighted private key.

The apparatus may further comprise
second means for generating the public key and the private key;
means for storing the private key in a secure hardware.

The means for obtaining the effective masking parameter may be configured to receive the effective masking parameter.

The means for obtaining the effective masking parameter may be configured to
generate a first masking parameter and a plurality of first masking parameter shares such that there is a respective first masking parameter share for each of plural devices and for the apparatus and the sum of the first masking parameter shares is equal to the first masking parameter;
receive, from each of the plural devices, a respective second masking parameter share; and
calculate the effective masking parameter as a difference of the first masking parameter and a sum of the first masking parameter share for the apparatus and the second masking parameter shares received from the plural devices;
   and the apparatus may further comprise
second means for providing each of the first masking parameter shares to the respective one of the plural devices.

The means for obtaining the effective masking parameter may be configured to
generate a first masking parameter;
receive, from each of plural devices, a respective second masking parameter; and
calculate the effective masking parameter as a difference of the first masking parameter and a sum of the second masking parameters received from the plural devices;
   and the apparatus may further comprise
   second means for providing the first masking parameter to each of the plural devices.

According to a fourth aspect, there is provided an apparatus, comprising
means for obtaining, for each of plural devices, a respective masking parameter and a sum of the masking parameters of the plural devices;
first means for providing, to each of the plural devices, the respective masking parameter;
second means for providing the sum of the masking parameters to a deciding unit.

The apparatus may further comprise
means for receiving a request for providing, to each of the plural devices, the respective masking parameter and, to the deciding unit, the sum of the masking parameters of the plural devices;
means for inhibiting the means for obtaining from obtaining, for any of the plural devices, the respective masking parameter and the sum of the masking parameters of the plural devices if the request for providing is not received.

The means for obtaining may be configured to generate, for each of the plural devices, the respective masking parameter by a random method and to obtain the sum of the masking parameters by adding the generated masking parameters of the plural devices.

The means for obtaining may be configured to generate the sum of the masking parameters by a random method and to obtain the respective masking parameter for each of the plural devices by sharing the generated sum of the masking parameters to the plural devices.

The apparatus may be one of the plural devices.

The apparatus may not be one of the plural devices.

According to a fifth aspect, there is provided a method, comprising
receiving a request to authenticate or authorize a requestor;
receiving, from each of plural devices, a respective masked weighted private key and, depending on a decryption algorithm, one of a respective encrypted vote or a value of a function of the respective encrypted vote and a weight for the respective device, wherein, for each of the plural devices, the respective weighted private key is a private key of the respective device weighted with the weight for the respective device;
calculating a functional decryption key based on a sum of the masked weighted private keys;
computing a sum of weighted votes of the plural devices by the decryption algorithm using the functional decryption key and the one of the encrypted votes from the plural devices or the values of the function of the encrypted vote and the weight from the plural devices, wherein, for each of the plural devices, the respective weighted vote is the vote from the respective device weighted with the weight for the respective device;
checking if the sum of the weighted votes fulfills a comparison criterion with respect to a threshold;
inhibiting to authenticate or authorize the requestor, respectively, if the sum of the weighted votes does not fulfill the comparison criterion with respect to the threshold.

The method may further comprise
authenticating or authorizing the requestor, respectively, if the sum of the weighted votes fulfills the comparison criterion with respect to the threshold.

The request to authenticate or authorize the requestor, respectively, may be received from one of the devices or from a further device different from each of the plural devices.

The method may further comprise
triggering each of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is received; and
inhibiting the triggering any of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is not received.

The comparison criterion may be fulfilled if the sum of the weighted votes is larger than or equal to the threshold.

The comparison criterion may be fulfilled if the sum of the weighted votes is smaller than or equal to the threshold.

The method may further comprise
receiving a value of a sum of masking parameters; wherein
the functional decryption key may be calculated by adding the encrypted masked weighted private keys from the plural devices to obtain an intermediate sum and subtracting the value of the sum of the masking parameters from the intermediate sum.

The value of the sum of the masking parameters may be received from a master device, wherein
the master device is one of the plural devices; or
the master device is not one of the plural devices.

The master device may be triggered to provide the value of the sum of the masking parameters if the request to authenticate or authorize the requestor, respectively, is received; and
the triggering the master device to provide the value of the sum of the masking parameters may be inhibited if the request to authenticate or authorize the requestor, respectively, is not received.

The value of the sum of the masking parameters may be received from a user.

The functional decryption key may be calculated by adding the encrypted masked weighted private keys from the plural devices.

According to a sixth aspect, there is provided a method, comprising
obtaining an effective masking parameter;
generating a masked weighted private key based on a private key, the effective masking parameter, and a weight;
determining a vote for authenticating or authorizing a requestor;
encrypting the vote by a public key;
providing the masked weighted private key and the encrypted vote to a deciding unit for deciding whether or not to authenticate or authorize the requestor, respectively, wherein the public key and the private key are a public/private key pair.

According to a seventh aspect, there is provided a method, comprising
obtaining an effective masking parameter;
generating a masked weighted private key based on a private key, the effective masking parameter, and a weight;
determining a vote for authenticating or authorizing a requestor;
encrypting the vote by a public key;
calculating a value of a function of the encrypted vote and the weight;
providing the masked weighted private key and the value of the function of the encrypted vote and the weight to a deciding unit for deciding whether or not to authenticate or authorize the requestor, respectively, wherein
the public key and the private key are a public/private key pair.

For the method according to any of the sixth and seventh aspects, one or more of the following may apply:

The weight may be preconfigured.

The method may further comprise receiving the weight.

The masked weighted private key may be generated by weighting the private key with the weight and adding the obtained effective masking parameter to the weighted private key.

The method may further comprise
generating the public key and the private key;
storing the private key in a secure hardware.

The effective masking parameter may be received.

The effective masking parameter may be obtained by
generating a first masking parameter and a plurality of first masking parameter shares such that there is a respective first masking parameter share for each of plural devices and for an apparatus performing the method and the sum of the first masking parameter shares is equal to the first masking parameter;
receiving, from each of the plural devices, a respective second masking parameter share; and
calculating the effective masking parameter as a difference of the first masking parameter and a sum of the first masking parameter share for the apparatus performing the method and the second masking parameter shares received from the plural devices;
   and the method may further comprise
providing each of the first masking parameter shares to the respective one of the plural devices.

The effective masking parameter may be obtained by
generating a first masking parameter;
receiving, from each of plural devices, a respective second masking parameter; and
calculating the effective masking parameter as a difference of the first masking parameter and a sum of the second masking parameters received from the plural devices;
   and the method may further comprise
   providing the first masking parameter to each of the plural devices.

According to an eighth aspect, there is provided a method, comprising
obtaining, for each of plural devices, a respective masking parameter and a sum of the masking parameters of the plural devices;
providing, to each of the plural devices, the respective masking parameter;
providing the sum of the masking parameters to a deciding unit.

The method may further comprise
receiving a request for providing, to each of the plural devices, the respective masking parameter and, to the deciding unit, the sum of the masking parameters of the plural devices;
inhibiting the obtaining, for any of the plural devices, the respective masking parameter and the sum of the masking parameters of the plural devices if the request for providing is not received.

For each of the plural devices, the respective masking parameter may be generated by a random method and the sum of the masking parameters may be obtained by adding the generated masking parameters of the plural devices.

The sum of the masking parameters may be generated by a random method and the respective masking parameter for each of the plural devices may be obtained by sharing the generated sum of the masking parameters to the plural devices.

An apparatus performing the method may be one of the plural devices.

An apparatus performing the method may not be one of the plural devices.

Each of the methods of the fifth to eighth aspects may be a method of multi-entity authentication or multi-entity authorization.

According to a ninth aspect, there is provided a computer program product comprising a set of instructions which, when executed on an apparatus, is configured to cause the apparatus to carry out the method according to any of the fifth to eighth aspects. The computer program product may be embodied as a computer-readable medium or directly loadable into a computer.

According to some example embodiments, at least one of the following advantages may be achieved:
another passwordless solution is provided;
private keys must not leave the respective device;
private keys cannot be derived based on eavesdropping the communication of the participants;
the votes of the devices are kept private.

### BRIEF DESCRIPTION OF THE DRAWINGS

Further details, features, objects, and advantages are apparent from the following detailed description of the preferred example embodiments which is to be taken in conjunction with the appended drawings, wherein:

FIG. 1 illustrates a SUMD scenario according to some example embodiments;

FIG. 2 illustrates a MUSA scenario according to some example embodiments;

FIG. 3 illustrates key storage within secure hardware or trusted element within a device according to some example embodiments;

FIG. 4 shows phase 2 of a method according to some example embodiments in the SUMD scenario;

FIG. 5 shows phase 2 of a method according to some example embodiments in the MUSA scenario;

FIG. 6 shows phases 3 and 4 of a method according to some example embodiments in the SUMD scenario;

FIG. 7 shows phases 3 and 4 of a method according to some example embodiments in the MUSA scenario;

FIG. 8 shows an apparatus according to an example embodiment;

FIG. 9 shows a method according to an example embodiment;

FIG. 10 shows an apparatus according to an example embodiment;

FIG. 11 shows a method according to an example embodiment;

FIG. 12 shows an apparatus according to an example embodiment;

FIG. 13 shows a method according to an example embodiment;

FIG. 14 shows an apparatus according to an example embodiment;

FIG. 15 shows a method according to an example embodiment; and

FIG. 16 shows an apparatus according to an example embodiment.

### DETAILED DESCRIPTION OF CERTAIN EXAMPLE EMBODIMENTS

Herein below, certain example embodiments are described in detail with reference to the accompanying drawings, wherein the features of the example embodiments can be freely combined with each other unless otherwise described. However, it is to be expressly understood that the description of certain example embodiments is given by way of example only, and that it is by no way intended to be understood as limiting the disclosure to the disclosed details.

Moreover, it is to be understood that the apparatus is configured to perform the corresponding method, although in some cases only the apparatus or only the method are described.

There are some main drawbacks of the current approaches that affect the security of passwordless authentication/authorization solutions.

Firstly, the credentials are secured using OS-specific password management software such as iOS Keychain and Android Keystore. The current passwordless solutions do not utilize secure hardware available on the user device (e.g., SIM cards). Such software-based implementations suffer from security weaknesses such as poor integrity and forgery protection, as well as information leaking of credentials to malicious apps and cold boot attacks. While storing the credentials on trusted hardware is possible, it is optional and left to the application developer's discretion. Similarly, synchronization of the same credentials across different devices and in the cloud makes such credentials the single point of failure. The credentials distributed across different devices are not used to impose strong access control for security-critical operations. Moreover, there are also interoperability issues if the credentials are to be synchronized between devices having different operating systems.

Some example embodiments address the weak credentials storage and synchronization by a method that can utilize any secure hardware. The secure hardware may be OS-independent. It may be readily-available, e.g., an Embedded Universal Integrated Circuit Card (eUICC)—using any of Subscriber Identity Module (SIM), embedded SIM (eSIM) or integrated SIM (iSIM).

Secondly, authorizing the keys stored on the device using the screen lock mechanism might not be sufficient for security-critical operations. An unlocked device is susceptible to, for example, evil maid attacks that can abuse the authorization mechanisms.

Some example embodiments address this problem with a distributed authentication/authorization mechanism. In the distributed authentication/authorization mechanism, votes or independent authentication/authorization by keys stored in different devices are consolidated to authenticate the requestor and/or authorize the requestor, for security-critical operations, for example. The distributed authentication/authorization mechanism is threshold-based. Thus, the overall security of the passwordless solutions is improved. Thus, a main advantage of some example embodiments is for security-critical operations or events associated with a user account, but example embodiments are not restricted to such operations or events.

A requestor may be a human being (sometimes also called a user) or a device. A device may be implemented as a hardware component, or as a software component, or as a combination of a hardware component and a software component, or in the cloud.

As explained at greater detail further below, the devices contributing to the distributed authentication/authorization mechanism, provide to a deciding unit (service provider) their masked weighted private keys and their votes for the authentication/authorization. The votes are encrypted with the public keys of the devices. In some example embodiments, instead of the encrypted votes, each of the devices provides, to the deciding unit, a function of the encrypted vote and the weight of the device. Whether the device provides the encrypted vote or the function of the encrypted vote and the weight of the device depends on the decryption algorithm and is, thus implementation specific.

In the following description of the scenarios and the respective methods, it is assumed that the service provider authenticates the requestor or authorizes the requestor to use the service of the service provider. However, in general, such authenticating/authorizing may be performed by a dedicated unit (“deciding unit”) which communicates with the service provider, preferably over a secure communication channel. Physically, the deciding unit may be integrated in the service provider or separated therefrom. Logically, the deciding unit may be a component of the service provider, for example, a software component of the software of the service provider, or a component logically separated from the service provider but in communication with the service provider.

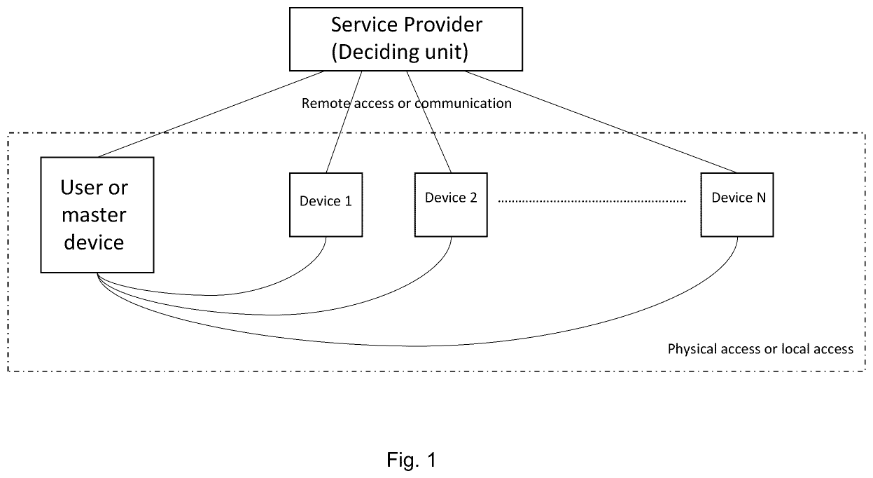

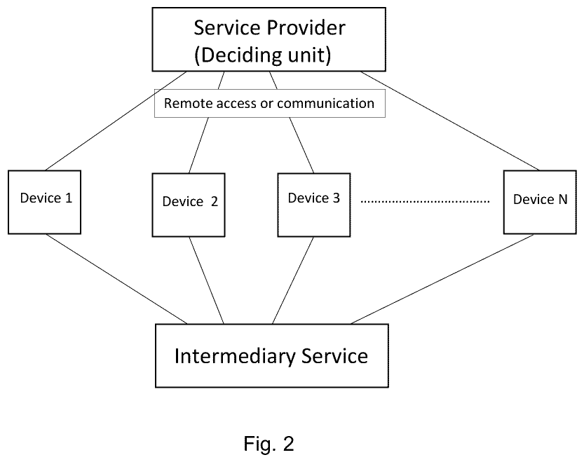

Example embodiments cover at least one of two scenarios:
Single user multiple device (SUMD) scenario, illustrated in FIGS. 1, 4, and 6; and
Multiple user single account (MUSA) scenario, illustrated in FIGS. 2, 5, and 7.

Single-user multiple-device (SUMD) scenario (FIG. 1): In this scenario, the user (in general: requestor) has multiple devices and the user wishes to use a service on all the devices. We assume that the user has physical access or local access with point-to-point communication channels (such as Bluetooth, NFC) to the devices, and can exchange information without relying on the service provider. It is also sufficient if the user has already authenticated to the service provider on each device. Each of the devices may independently communicate with the service provide r (more precisely: the deciding unit), e.g., over the Internet.

In some example embodiments, a user may manage the devices providing their masked weighted private keys and their encrypted votes according to some example embodiments. In some example embodiments, a master device may manage the devices providing their masked weighted private keys and their encrypted votes according to some example embodiments. The master device may be one of the devices providing their masked weighted private keys and their encrypted votes or different from each of the devices providing their masked weighted private keys and their encrypted votes. Managing the devices may include mediating the communication between the devices when required.

Multiple-user single-account (MUSA) scenario (FIG. 2): In this scenario, multiple users (in general: requestors) share a single account or service through their individual devices. It is assumed that the devices can communicate with each other, directly or using intermediary or third-party relay services (such as emails or SMS). Furthermore, each of the devices can independently communicate with the service provider (more precisely: the deciding unit), e.g., over the Internet.

A main difference between SUMD and MUSA is that in the former scenario there is a centralized control of all endpoints (devices), i.e., the user or master device controlling all the devices. In the latter scenario, there is no single entity controlling each endpoint as they are on their own.

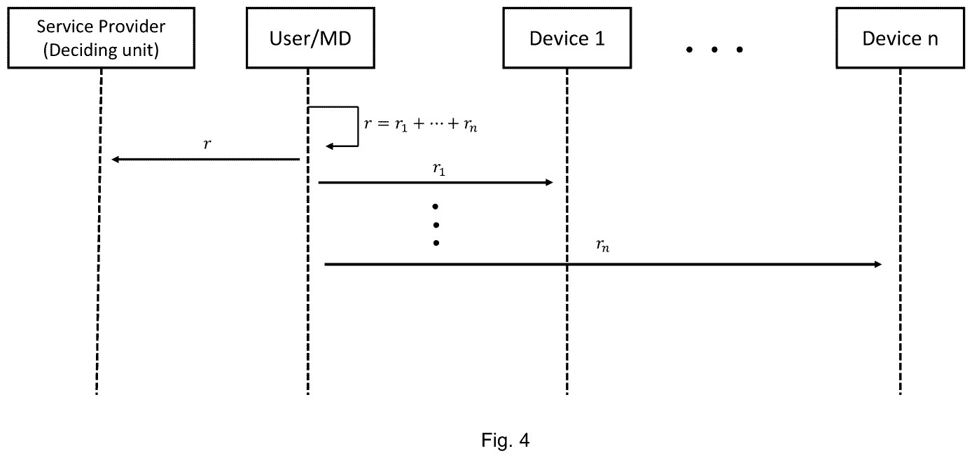

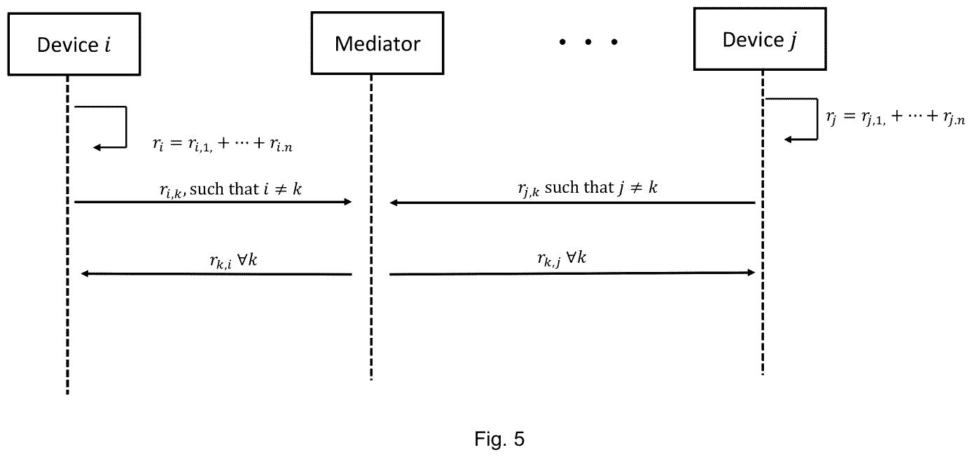

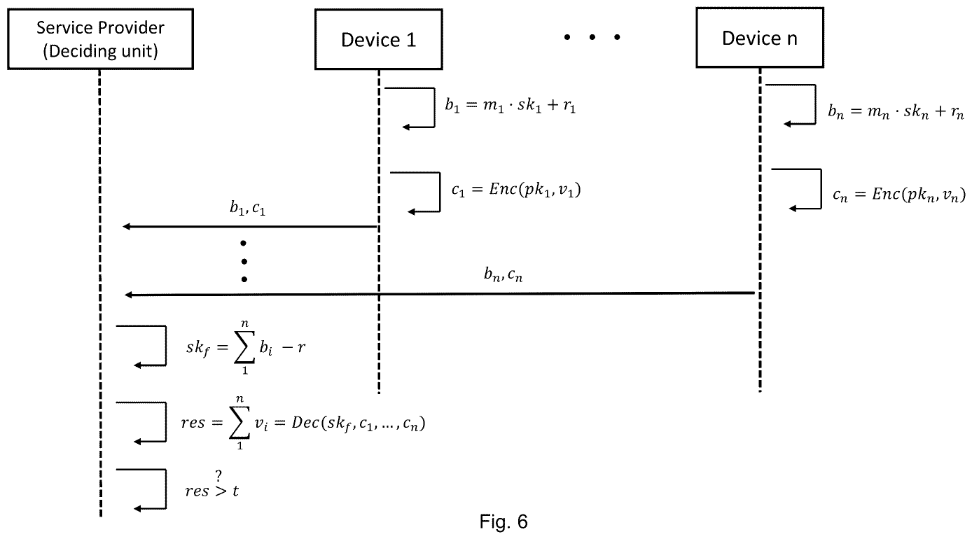

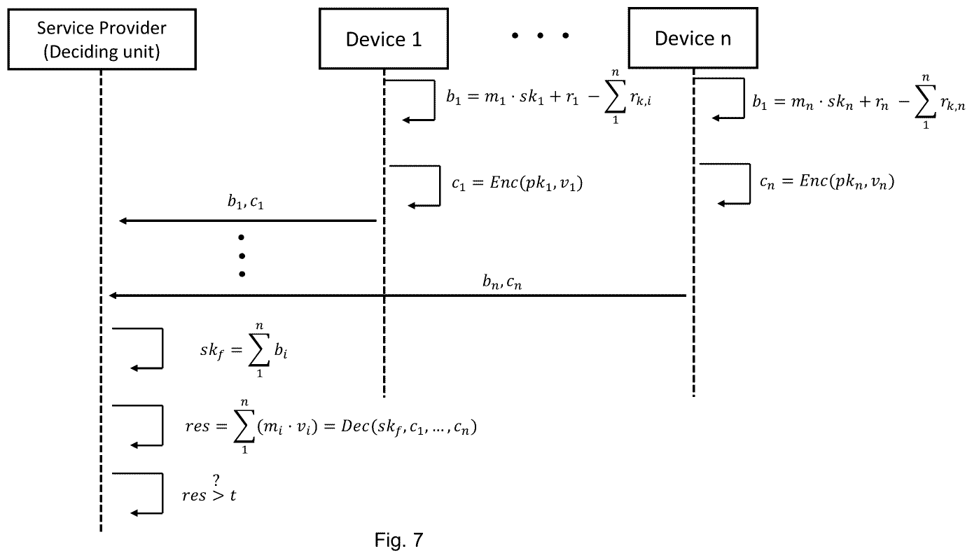

According to some example embodiments, for each of the SUMD and MUSA scenarios, there are up to four phases as follows:
Phase 1: Key generation and storage: In this phase, the cryptographic keys (a public/private key pair) used for authentication are generated and stored on the device. In some example embodiments, they may be stored on a secure hardware (such as SIM, TPM, or TEE) if that is readily available on the device. The secure hardware may be OS-independent. Typically, the keys are generated on the device (device-specific keys) to avoid synchronization of a single key across devices and/or cloud for better security. At the end of this phase, each device participating in the method has a key that can be used to authorize an operation of the device. In some example embodiments, the keys are generated and stored independent from the remaining phases. I.e., in such example embodiments, the keys may be considered as a prerequisite for performing the method and key generation does not belong to the method.
Phase 2: Shares generation and distribution (FIGS. 4 and 5): The purpose of this phase is to equip each device with a parameter (masking parameter) to mask their secret keys. This phase is different for the SUMD scenario and the MUSA scenario:
   SUMD scenario: A user (administrator) or the master device sends the parameter r to the service provider. Moreover, the user or the master device splits r into n shares and distributes them to the n devices (one share to each one of the devices). Alternatively, the user or the master device may generate the shares and calculate the parameter r as the sum of the shares. Each device uses the received share as the masking parameter.
   MUSA scenario: The masking parameters are generated by the devices themselves and distributed between them. For the details, it is referred to the detailed description further below.
Phase 3: Voting (FIGS. 6 and 7): In phase 3, each device will cast an independent vote on whether to authenticate/authorize the requestor. At the end of this phase, the service provider (deciding unit) has a respective vote from each device for deciding whether the requestor should be authenticated/authorized. Moreover, the deciding unit receives n masked keys from each of the n devices (one masked key per each one of the devices). In some example embodiments, only a fraction of the devices having a public/private key pair from phase 1 (or as a prerequisite) may provide a vote to the service provider.
Phase 4: Result computation and decision on authentication/authorization (FIGS. 6 and 7): In this phase, the service provider first computes a functional decryption key from the n masked keys. Then, the service provider performs a functional decryption of the entirety of the votes to obtain a sum of weighted votes. The sum of the weighted votes is used to decide whether the requestor should be authenticated/authorized based on a comparison with the value of a threshold t.

The threshold t may be a default value or a value defined by a system administrator. Since the threshold t is used only on the side of the service provider, it is not required to communicate the threshold t with any devices participating in the method. For the threshold, one may distinguish between two cases:

Case 1 (Static number of devices): If there is a static number of devices, the threshold may be set only once (a default value or a value set by the administrator) and then be used until the system administrator decides to change the value of the threshold.

Case 2 (Dynamic number of devices): If the number of devices changes over time (which might be the most common case), there are two different options to set the threshold value:
Option 1: The threshold value t is incremented by a value x each time a new device joins, and is decreased by the same value x if a device is removed from the system. The value x can be a default value or a value set by the system administrator.
Option 2: Each time the votes are collected, the server computes their average value (more precisely: the average of the weighted votes). Hence, the value of the threshold is independent of the number of the devices and depends on the values of the votes and the weights, if any.

The phases 1 to 4 of methods according to some example embodiments are described at greater detail hereinafter. First, the principle of Functional Encryption (FE) is generally described.

### Functional Encryption (FE)

Some example embodiments rely on Functional Encryption (FE), a cryptographic primitive that allows computations on encrypted data. More precisely, in an FE scheme, devices independently generate their public/private key pairs (pkᵢ, skᵢ) for a public key encryption scheme. Then, each device encrypts their plaintext data xᵢ locally using their own public key, resulting in a ciphertext cᵢ. As a next step, devices can jointly compute functional decryption keys sk_{ƒ}_{ᵢ} for specific functions ƒᵢ. Finally, decrypting the ciphertexts c₁, c₂, . . . , cₙ using the decryption key sk_{ƒ}_{ᵢ}, yields ƒᵢ(x₁, . . . , xₙ). In the case where the function ƒᵢ represents a summation function, then the functional decryption key is computed as

$${sk}_{{f}_{i}} = {Σ}_{1}^{n} {sk}_{i} .$$

Similarly, if ƒᵢ is an inner-product function for the vectors x=(x₁, . . . , xₙ) and y=(y₁, . . . , yₙ), the functional decryption key is computed as

$${sk}_{{f}_{i}} = {\sum }_{1}^{n} {sk}_{i} \cdot {y}_{i} .$$

A main building block of a FE scheme is a public key encryption (PKE) scheme, such as a traditional (conventional) public key encryption scheme. A public key encryption (PKE) scheme, such as a traditional (conventional) PKE scheme, comprises three algorithms: Setup, Encryption, and Decryption such that:
1. PKE.Setup: Takes as input a security parameter and outputs a public/private key pair (pk,sk)
2. PKE.Enc: Takes as input a plaintext message x and a public key pk and outputs a ciphertext c
3. PKE.Dec: Takes as input a ciphertext c and a private key sk and outputs the plaintext x

A PKE encryption scheme is used as a main building block of an FE scheme. More specifically, an FE comprises four algorithms: Setup, Encryption, KeyGeneration, and Decryption:
1. FE.Setup: This algorithm takes as input a security parameter and outputs n public/private key pairs (pkᵢ, skᵢ) by internally running n different instances of PKE.Setup. This algorithm can be either executed by a central authority that distributes the key pairs to different entities, or it can be run independently by each entity on each own. In the latter case, FE.Setup is identical to PKE.Setup as each entity only needs one public/private key pair.
2. FE.Enc: This algorithm takes as input a message xᵢ and a public key pkᵢ and internally runs PKE.Enc to procude a ciphertext cᵢ
3. FE.KeyGen: This algorithm takes as input n different private keys (sk₁, . . . , skₙ) and the description of a function ƒ and outputs a functional decryption key sk_{ƒ}.
4. FE.Dec: This algorithm takes as input n ciphertexts (c₁, . . . , cₙ) and the functional decryption key sk_{ƒ} and outputs ƒ(x₁, . . . , xₙ)

Note that in contrast to traditional public key cryptography, the decryption algorithm does not return the values x₁, . . . , xₙ but the result ƒ(x₁, . . . , xₙ) and thus, keeps each of the xᵢ values private.

More in detail, in a FE scheme, each device generates a ciphertext cᵢ. Since FE is built on a public-key encryption (PKE) scheme, the specifics of ciphertext generation—and, by extension, decryption—depend on the choice of the underlying PKE scheme and is, thus, are implementation specific.

Depending on the underlying PKE scheme, in some example embodiments, weight information is not included in the ciphertext. Instead, this information is encoded within the functional decryption key. If other PKE schemes are used, the weight is embedded directly in the ciphertext to ensure correct computations during decryption. That is, for such PKE schemes, the ciphertext is a value of a function of the message xᵢ (such as the vote) encrypted by the public key pkᵢ and the weight. Whether or not the weight is used for generating the ciphertext depends on the mathematical properties of the implemented PKE scheme. If the ciphertext is a value of a function of the message xᵢ (such as the vote) encrypted by the public key pkᵢ and the weight, the function depends on the implemented PKE scheme.

Hereinafter, we explain at greater detail two examples (ElGamal scheme, Regev scheme as the PKE scheme) where the weight is embedded in the ciphertext and an example (bilinear pairing as the PKE scheme) where the weight is not embedded in the ciphertext.

An example of an FE scheme where the weight is embedded in the ciphertext according to some example embodiments is as follows: If the PKE scheme serving as the main building block of the FE scheme is ElGamal or the Regev cipher, the FE decryption algorithm executes the corresponding ElGamal or Regev decryption algorithms. In this process, the functional decryption key acts as the decryption key, and the ciphertext to be decrypted is formed by multiplying or adding all the individual ciphertexts for the ElGamal and Regev scheme, respectively.

A decryption example using the ElGamal encryption scheme as the main building block of the FE scheme according to some example embodiments is the following:

Assuming that there are n ElGamal ciphertexts c₁, . . . , cₙ of n devices. Each device will calculate cᵢ^{m}^{ᵢ}, wherein mᵢ is the respective weight.

Furthermore, we assume that the functional decryption key sk_{ƒ} is already calculated. Then the decryptor computes:

$$FE . Dec ( {sk}_{f} , {c}_{1} , … , {c}_{n} ) = PKE . Dec ( {sk}_{f} , {\prod }_{1}^{n} {c}_{i}^{{m}_{i}} ) = PKE . Dec ( {sk}_{f} , {\prod }_{1}^{n} PKE . {Enc ( {pk}_{i} , x )}^{{m}_{i}} ) = PKE . Dec ( {sk}_{f} , PKE . Enc ( {\prod }_{1}^{n} {pk}_{i}^{{m}_{i}} , {\sum }_{1}^{n} {w}_{i} {x}_{i} ) ) = {\sum }_{1}^{n} {m}_{i} {x}_{i}$$

For this calculation, the following properties of the ElGamal encryption schemes are exploited:
For any two valid key pairs (pk₁, sk₁), (pk₂, sk₂) any vectors w₁, w₂ the linear combination w₁sk₁+w₂sk₂ is a valid secret key to a public key computes as pk₁^{w}^{₁}pk₂^{w}^{₂}.
It holds that:

$$PKE . Enc ( {pk}_{1} {pk}_{2} , {x}_{1} + {x}_{2} ) = PKE . Enc ( {pk}_{1} , {x}_{1} ) PKE . Enc ( {pk}_{2} , {x}_{2} )$$

Another similar example is the Regev's cipher which is also believed to be quantum resistant. However, since in Regev's cipher the public keys are non-square matrices of equal dimensions, multiplication of public keys is not possible. To this end, the operations are modified by substituting the products with summations.

An example of an FE scheme where the weight is not embedded in the ciphertext is using bilinear pairing as the PKE scheme. The FE scheme works substantially as follows:

### 1. Setup

Let e be a bilinear pairing e: G₁×G₂→G_{T} where G₁, G₂ and G_{T} are cyclic groups of prime order p. Moreover let g be a generator of G₁ and h a generator of G₂, both public. The public and private keys are generated in the same way as in ElGamal. The functional decryption key is again the weighted linear combination of the private keys along with the weights.

### 2. Encryption

Each cyphertext cᵢ is calculated as (c₀, c₁) where c₀=g^{r} and c₁=g^{r}h^{x}^{ᵢ} (the weight is not involved here at all), where the value r is a random value that is used to ensure that the encryption is probabilistic (i.e. encrypting the same ciphertexts multiple times, yields a different result each time).

### 3. Decryption

First, the decryptor computes the product sk_{ƒ}h (lets denote that as sk_{ƒ}′) and then does the pairing computation as:

$$e ( {c}_{0} , {sk}_{f}^{′} ) = e ( {g}^{r} , {\sum }_{1}^{n} ( {sk}_{i} , {m}_{i} ) h )$$

$$and$$

$$e ( {c}_{i} , {sk}_{f}^{′} ) = e ( {g}^{r} , {h}_{i}^{x} , {\sum }_{1}^{n} ( {sk}_{i} , {m}_{i} ) h )$$

Using the bilinearity property of the pairing we get:

$$e ( {c}_{i} , {sk}_{f}^{′} ) = e ( {g}^{r} , {\sum }_{1}^{n} ( {sk}_{i} , {m}_{i} ) h ) e ( {h}^{{x}_{i}} , {\sum }_{1}^{n} ( {sk}_{i} , {m}_{i} ) h )$$

The first part of the term includes the randomness while the second the plaintext messages xᵢ. However, after expanding in the second term, one can reveal the term xᵢyᵢ and then extract it assuming that the bilinear pairing e is correctly structured to allow for such extraction (which is the case when using standard cryptographic pairings).

### Phase 1—Key Generation and Storage:

In some example embodiments, each device generates a public/private key pair (pkᵢ, skᵢ) independently using a public-key encryption scheme that can be used as a basis for Functional Encryption. There are several options that can be employed for key generation and storage in phase 1. Conventional examples are such as SIMBA, GSMA RSP or Passkeys. There are available schemes based on traditional hardness assumptions such as decisional Diffie-Hellman or even post-quantum ones such as LWE. The scheme may be selected according to the needs of the implementation. Naturally, the private key generated during this phase may be used to sign authentication requests while the public key may be used to encrypt messages.

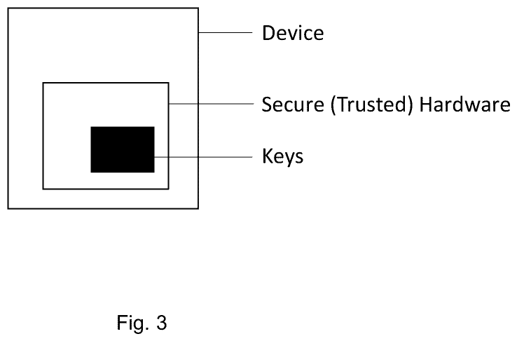

In some example embodiments, at least the private key is stored on a secure hardware or trusted element on the device (refer to FIG. 3). Preferably, the secure hardware is OS-independent. SIMBA and RSP already offer this functionality by storing the keys in the eUICC or SIM. In the case of passkeys, storing the keys on trusted hardware such as HSM, TPM or TEE is recommended.

Either during this phase 1, or latest in phase 4, the service provider generates the threshold t or receives the threshold t from a user (administrator) or from some other entity.

### Phase 2—Shares Generation and Distribution:

Phase 2 is different for the SUMD scenario and the MUSA scenario. They are described separately hereinafter.

In each of these scenarios, first a respective weight mᵢ may be assigned to each of the devices. For example, in the SUMD scenario, the master device may assign a respective weight mᵢ to each of the devices. As another option, a user (such as an administrator) may assign the weight mᵢ to some or all of the devices. In the SUMD scenario, the user for assigning the weights may be the same as or different from the user for creating the shares and the masking parameter r. The weights mᵢ may be predefined for each of the devices. The weights for different devices may be different or the same. In some example embodiments, the weights for all the devices are the same. For simplicity, in this case, one may assume that all the weights are 1 (mᵢ=1 for all values of i).

2a—SUMD scenario (FIG. 4): In phase 2 of the SUMD scenario, the devices collaborate to enable the service provider to compute a functional decryption key. Namely, the different devices engage in a Multi-Party Computation (MPC) protocol that will allow the service provider to compute the functional decryption key for an inner-product function. Normally, in an MPC protocol, some parameters are generated and distributed to the different parties. In the SUMD case, these parameters are generated by a master device and then passed to the devices participating in the voting.

For example, in an MPC protocol, like the one described in https://eprint.iacr.org/2021/1692, the master device generates a random number r and then writes it as r==r₁+ . . . +rₙ. The shares rᵢ may be defined by a deterministic algorithm such as rᵢ=r/n, or at least some of the shares may be determined by a random function and the remaining shares, if any, may be determined by a deterministic algorithm based on the difference of the random number rand the randomly determined shares. As another option, the master device may generate the shares rᵢ (e.g. based on a random function) and calculate the number r as r=r₁+ . . . +rₙ based on the generated shares.

As a next step, the master device provides the corresponding share rᵢ to each device dᵢ and provides the value r to the service provider.

The devices do not provide their private keys to the service provider but first mask their individual private keys skᵢ as mᵢ·skᵢ+rᵢ and then provide their masked private keys to the service provider. Then, the service provider may calculate the sum of the weighted private keys to obtain the functional decryption key for a summation function (if all the weights are 1) or for an inner product with the weights by computing sk_{ƒ}=Σ₁ⁿ[(mᵢ·skᵢ]+r=<mᵢ,skᵢ>.

As another option, the devices may send their masked weighted private keys to the master device which may calculate the sum of the weighted private keys (i.e. the functional decryption key) in the same way as described for the service provider. Then, the master device sends the functional decryption key to the service provider. In this case, the master device need not to inform the service provider about the value of the random number r.

As still another option, another device, such as one of the devices providing its masked weighted private key and the encrypted vote, or still another device, may receive the random number r from the master device and the masked weighted private keys from all the devices, calculate the sum of the weighted private keys (i.e. the functional decryption key) in the same way as described for the service provider, and provide the functional decryption key to the service provider (deciding unit).

2b—MUSA scenario (FIG. 5): A main difference between phases 2a of the SUMD scenario and phase 2b of the MUSA scenario is that in phase 2b the shares required for the generation of the functional decryption key are distributed among the devices, for example through an intermediary or third party (e.g. an email provider) or directly between the devices contributing to the voting. Moreover, the shares are not generated by a user (such as an administrator) or the master device rather than on each device individually.

In the MUSA scenario, the MPC may work as follows:

Each device dᵢ generates a device specific random number rᵢ and writes it as rᵢ=r_{i,1}+ . . . +r_{i,n}. As another option, each device may generate the shares r_{i,j} and calculate the device specific random number rᵢ as the sum of the generated shares. As described for the master device in the SUMD case, at least some of the device specific random number and the shares may be generated by a random function.

As a next step, each of the devices dᵢ sends the share r_{i,j} to the corresponding device dj, for each of the devices dⱼ, j=1 . . . n, j≠i. The device dᵢ keeping the share r_{i,i}. After all the devices have generated and shared their shares, each device has received n−1 shares from the other devices. Each device dᵢ then masks its secret key by computing

$${b}_{i} = {m}_{i} {sk}_{i} + {r}_{i} - {\sum }_{1}^{n} {r}_{ki}$$

and sends the value of bᵢ to the service provider. After the service provider has collected all n masked weighted private keys from the n devices, the service provider can compute the functional decryption key as

$${sk}_{f} = {\sum }_{1}^{n} bj = < {m}_{i} , {sk}_{i} >$$

The method is explained more specifically for the following example with 4 devices d1, d2, d3, d4. Each device generates a device specific random number rᵢ and splits it into 4 shares. Hence, there is:

$${r}_{1} = {r}_{11} + {r}_{12} + {r}_{13} + {r}_{14}$$

$${r}_{2} = {r}_{21} + {r}_{22} + {r}_{23} + {r}_{24}$$

$${r}_{3} = {r}_{31} + {r}_{32} + {r}_{33} + {r}_{34}$$

$${r}_{4} = {r}_{41} + {r}_{42} + {r}_{43} + {r}_{44}$$

Now each device sends a respective share to each of the other devices keeping only one share rᵢᵢ private. So, device d₁ keeps r₁₁ private and sends r₁₂ to d₂, r₁₃ to d₃, and r₁₄ to d₄. Similarly, device d₂ keeps r₂₂ private and distributes the other shares to the devices d₁, d₃, and d₄, etc. Thus, each device receives 3 (=n−1 for n=4) shares from the other 3 devices.

When each device receives the n−1 shares from the other devices, each device dᵢ calculates:

$${b}_{i} = {m}_{i} {sk}_{i} + {r}_{i} - {\sum }_{1}^{n} {r}_{ki}$$

where rₖᵢ are the received shares (for i≠k) and the share rᵢᵢ kept private by the device dᵢ.

As a result:

$${b}_{1} = {m}_{1} {sk}_{1} + {r}_{1} - {\sum }_{1}^{n} {r}_{k 1} = {m}_{1} {sk}_{1} + {r}_{1} - ( {r}_{11} + {r}_{21} + {r}_{31} + {r}_{41} )$$

$${b}_{2} = {m}_{2} {sk}_{2} + {r}_{2} - {\sum }_{1}^{n} {r}_{k 2} = {m}_{2} {sk}_{2} + {r}_{2} - ( {r}_{12} + {r}_{22} + {r}_{32} + {r}_{42} )$$

$${b}_{3} = {m}_{3} {sk}_{3} + {r}_{3} - {\sum }_{1}^{n} {r}_{k 3} = {m}_{3} {sk}_{3} + {r}_{3} - ( {r}_{13} + {r}_{23} + {r}_{33} + {r}_{43} )$$

$${b}_{4} = {m}_{4} {sk}_{4} + {r}_{4} - {\sum }_{1}^{n} {r}_{k 4} = {m}_{4} {sk}_{4} + {r}_{4} - ( {r}_{14} + {r}_{24} + {r}_{34} + {r}_{44} )$$

By computing

$${\sum }_{1}^{n} {b}_{i} ,$$

one obtains:

$$\begin{matrix}{b}_{1} + {b}_{2} + {b}_{3} + {b}_{4} = {m}_{1} {sk}_{1} + {m}_{2} {sk}_{2} + {m}_{3} {sk}_{3} + {m}_{4} {sk}_{4} + {r}_{1} + {r}_{2} + {r}_{3} + {r}_{4} - \\ ( {r}_{11} + {r}_{21} + {r}_{31} + {r}_{41} ) - ( {r}_{12} + {r}_{22} + {r}_{32} + {r}_{42} ) - \\ ( {r}_{13} + {r}_{23} + {r}_{33} + {r}_{43} ) - ( {r}_{14} + {r}_{24} + {r}_{34} + {r}_{44} ) \\ = {\sum }_{1}^{4} {m}_{i} {sk}_{i} + {r}_{1} + {r}_{2} + {r}_{3} + {r}_{4} - ( {r}_{11} + {r}_{12} + {r}_{13} + {r}_{14} ) - \\ ( {r}_{21} + {r}_{22} + {r}_{23} + {r}_{24} ) - ( {r}_{31} + {r}_{32} + {r}_{33} + {r}_{34} ) - \\ ( {r}_{41} + {r}_{42} + {r}_{43} + {r}_{44} ) \\ = {\sum }_{1}^{4} {m}_{i} {sk}_{i} + {r}_{1} + {r}_{2} + {r}_{3} + {r}_{4} - {r}_{1} - {r}_{2} - {r}_{3} - {r}_{4} = \\ {\sum }_{1}^{n} {m}_{i} {sk}_{i}\end{matrix}$$

i.e. the sum of the weighted private keys, which is the functional decryption key.

This method has the advantage that the share rᵢᵢ may never leave the respective device dᵢ. Thus, an attacker cannot obtain the private key skᵢ by eavesdropping the distributed shares and the masked weighted private keys.

As an alternative option, each of the devices dᵢ may generate just the device specific random number rᵢ and distribute this device specific random number to the other devices and to the service provider. The devices calculate the masked weighted private keys as

$${b}_{i} = {m}_{i} {sk}_{i} - {\sum }_{1}^{n} {r}_{k} .$$

The service provider may calculate

$${\sum }_{1}^{n} {b}_{i} + n * {\sum }_{1}^{n} {r}_{k} ,$$

wherein the latter term is obtained from the device specific random number provided by the devices to the service provider. Thus, the service provider obtains Σ₁ⁿmᵢskᵢ, i.e., the sum of the weighted private keys, which is the functional decryption key.

The alternative option needs less calculation effort. However, if an attacker eavesdrops the random numbers and the masked weighted private keys, they may derive the private keys of the devices. Thus, the alternative option is less secure.

Other alternative options are conceivable, too. For example, the masking may be performed by adding the sum of the shares instead of by subtracting them. The algorithm at the service provider has to be adapted correspondingly.

As may be seen from the description of the phases 2a and 2b, each of the devices masks its private key by an effective masking parameter, which may be generated by the master device (in the SUMD scenario) or based on a number generated by the device itself and numbers (shares) received from the other devices. The service provider obtains the functional decryption key based on a sum of the masked weighted private keys.

In some example embodiments, the procedure of phase 2b explained for the MUSA scenario may be applied to the SUMD scenario instead of the procedure of the phase 2a. Thus, even in the MUSA scenario, a master device is not needed.

### Phase 3—Voting (FIGS. 6 and 7):

Each device dᵢ generates a vote v_{di} for the authentication/authorization of the requestor. As a next step, the vote is encrypted with the device's public key pkᵢ. Depending on the implemented FE scheme (and the underlying PKE scheme) either the encrypted vote is the resulting ciphertext cᵢ, or the device calculates a function of the encrypted vote and the weight of the device to obtain the ciphertext cᵢ Upon its generation, the ciphertext cᵢ is sent to the service provider.

There are two options to deduce the respective votes on each of the devices (endpoints).
Option 1—measurement-based voting: If the voting endpoint is a device, it can deduce the vote based on, for example, measurements or reading through sensors. Furthermore, each device can perform some analytics or more calculations on the measured data to deduce the votes.
Option 2—user-based voting: If the voting endpoint is a human user, he/she can use their rationale or opinions to deduce the vote.

### Phase 4—Result Computation and Decision on Authentication/Authorization (FIGS. 6 and 7):

Upon gathering all the encrypted votes (or the values of the function of the encrypted vote and the weight, depending on the implemented FE scheme) and the masked keys, the service provider will first compute the functional decryption key (as described for phase 2) and then run the FE decryption algorithm. The inputs to the FE decryption algorithm are the functional decryption key along with the n encrypted votes or the n values of the function of the votes and the weights, depending on the implemented FE scheme. The encrypted votes or the values of the function are the ciphertexts of the FE decryption algorithm. The computation will yield a result

$$res = {\sum }_{1}^{n} {m}_{i} \cdot {v}_{i} .$$

The server then compares res with a threshold t to decide whether or not the requestor will be authenticated/authorized.

For example, in case the larger the vote of a device the more the device agrees to the authentication/authorization and the weights are positive values, the service provider compares the result res with the threshold t and, if the result res is larger than the threshold t, the service provider authenticates/authorizes the requestor, and if the result res is smaller than the threshold t, the service provider inhibits the authorization/authentication of the requestor. Correspondingly, in case the smaller the vote of a device the more the device agrees to the authentication/authorization and the weights are positive values, the service provider compares the result res with the threshold t and, if the result res is smaller than the threshold t, the service provider authenticates/authorizes the requestor, and if the result res is larger than the threshold t, the service provider inhibits the authorization/authentication of the requestor.

The procedure may be triggered by a request for authentication/authorization. For example, the request for authentication/authorization may be included in or implied by a request to provide a service by the service provider. In some example embodiments, the devices (and/or the master device in case of the SUMD scenario) may perform phase 1 and the subsequent phases 2, 3, and 4 only upon receipt of such a request. In some other example embodiments, the devices (and/or the master device in case of the SUMD scenario) may perform phase 2 and the subsequent phases 3 and 4 only upon receipt of such a request but may perform phase 1 independent from such a request. In still some other example embodiments, the devices may perform phases 3 and 4 only upon receipt of such a request but may perform phases 1 and 2 independent from such a request.

Phase 1 is optional. Instead of generating the public/private key pair as part of the method according to some example embodiments, the public/private key pairs may be generated independent from the method according to some example embodiments and provided to the devices as a prerequisite for the phases 2 to 4 of the method according to some example embodiments.

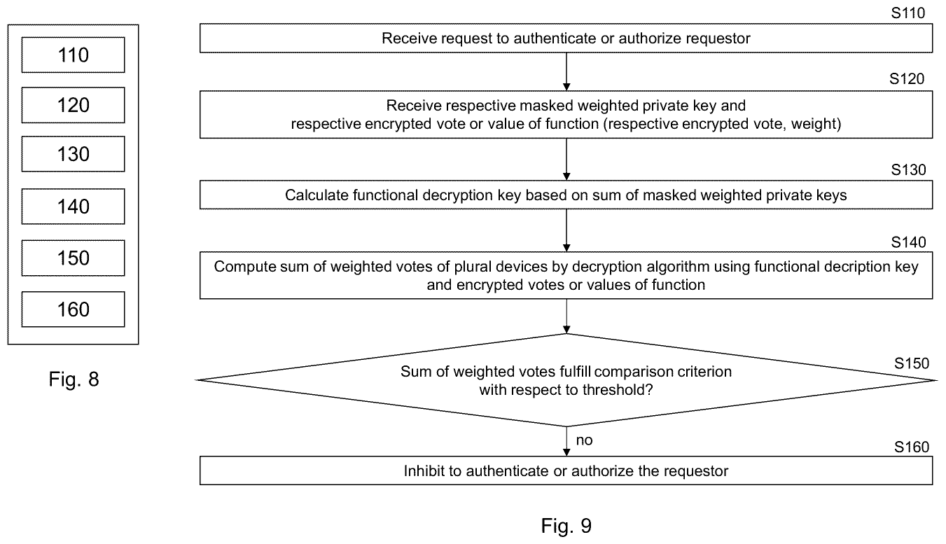

FIG. 8 shows an apparatus according to an example embodiment. The apparatus may be a service provider or an element thereof (such as a deciding unit). FIG. 9 shows a method according to an example embodiment. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises first means for receiving 110, second means for receiving 120, means for calculating 130, means for computing 140, means for checking 150, and means for inhibiting 160. The first means for receiving 110, second means for receiving 120, means for calculating 130, means for computing 140, means for checking 150, and means for inhibiting 160 may be a first receiving means, second receiving means, calculating means, computing means, checking means, and inhibiting means, respectively. The first means for receiving 110, second means for receiving 120, means for calculating 130, means for computing 140, means for checking 150, and means for inhibiting 160 may be a first receiver, second receiver, calculator, computer, checker, and inhibitor, respectively. The first means for receiving 110, second means for receiving 120, means for calculating 130, means for computing 140, means for checking 150, and inhibiting 160 may be a first receiving processor, second receiving processor, calculating processor, computing processor, checking processor, and inhibiting processor, respectively.

The first means for receiving 110 receives a request to authenticate or authorize a requestor (S110).

The second means for receiving 120 receives from each of plural devices, a respective masked weighted private key (S120). For each of the plural devices, the respective weighted private key is a private key of the respective device weighted with a weight for the respective device.

In addition, the second means for receiving 120 receives from each device a respective encrypted vote or a value of a function of the respective encrypted vote and the weight for the respective device (S120). Whether the second means for receiving 120 receives from the plural devices the encrypted votes or the values of the function of the encrypted vote and the weight depends on the decryption algorithm used in S140. That is, the selection among the encrypted votes and the values of the function of the encrypted vote and the weight depends on the implementation of the example embodiment.

The means for calculating 130 calculates a functional decryption key based on a sum of the masked weighted private keys (S130).

The means for computing 140 computes a sum of weighted votes of the plural devices by a decryption algorithm (S140). The decryption algorithm uses the functional decryption key and the encrypted votes from the plural devices or the values of the function of the encrypted vote and the weight received in S120. For each of the plural devices, the respective weighted vote is the vote from the respective device weighted with the weight for the respective device.

The means for checking 150 checks if the sum of the weighted votes fulfills a comparison criterion with respect to a threshold (S150).

The means for inhibiting 160 inhibits to authenticate or authorize the requestor, respectively, if the sum of the weighted votes does not fulfill the comparison criterion with respect to the threshold (S160).

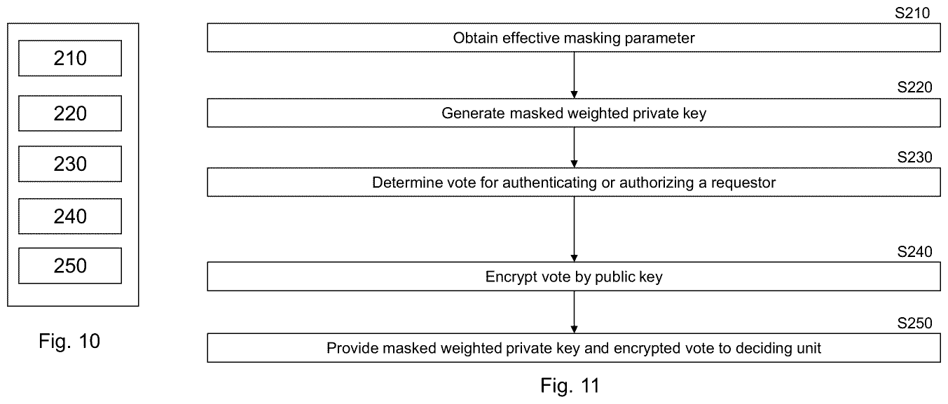

FIG. 10 shows an apparatus according to an example embodiment. The apparatus may be a device participating in a voting or an element thereof. FIG. 11 shows a method according to an example embodiment. The apparatus according to FIG. 10 may perform the method of FIG. 11 but is not limited to this method. The method of FIG. 11 may be performed by the apparatus of FIG. 10 but is not limited to being performed by this apparatus.

The apparatus comprises means for obtaining 210, means for generating 220, means for determining 230, means for encrypting 240, and means for providing 250. The means for obtaining 210, means for generating 220, means for determining 230, means for encrypting 240, and means for providing 250 may be a obtaining means, generating means, determining means, encrypting means, and providing means, respectively. The means for obtaining 210, means for generating 220, means for determining 230, means for encrypting 240, and means for providing 250 may be a obtainer, generator, determiner, encrypter, and provider, respectively. The means for obtaining 210, means for generating 220, means for determining 230, means for encrypting 240, and providing 250 may be a obtaining processor, generating processor, determining processor, encrypting processor, and providing processor, respectively.

The means for obtaining 210 obtains an effective masking parameter (S210). The means for generating 220 generates a masked weighted private key based on a private key, the effective masking parameter, and a weight (S220).

The means for determining 230 determines a vote for authenticating or authorizing a requestor (S230). The means for encrypting 240 encrypts the vote by a public key (S240). The public key used in S220 and the private key used in S240 are a public/private key pair.

The means for providing 250 provides the masked weighted private key and the encrypted vote to a deciding unit for deciding whether or not to authenticate or authorize the requestor, respectively (S250).

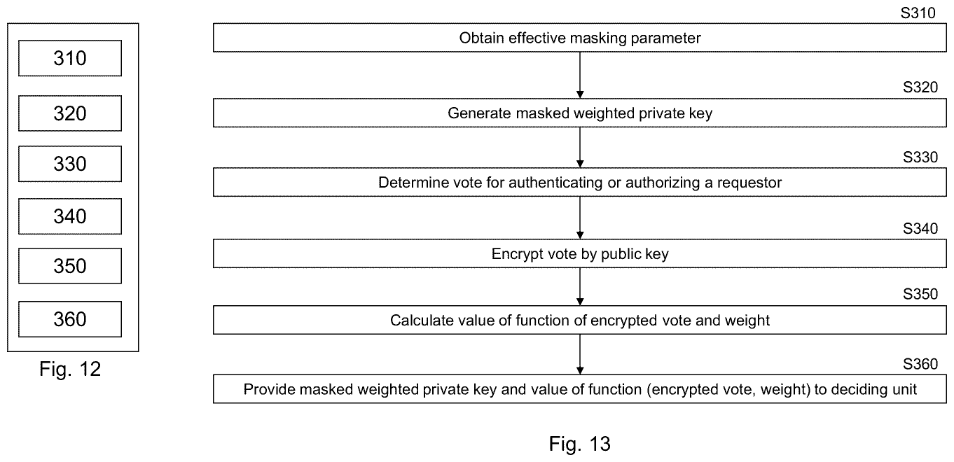

FIG. 12 shows an apparatus according to an example embodiment. The apparatus may be a device participating in a voting or an element thereof. FIG. 13 shows a method according to an example embodiment. The apparatus according to FIG. 12 may perform the method of FIG. 13 but is not limited to this method. The method of FIG. 13 may be performed by the apparatus of FIG. 12 but is not limited to being performed by this apparatus.

The apparatus comprises means for obtaining 310, means for generating 320, means for determining 330, means for encrypting 340, and means for providing 360. The means for obtaining 310, means for generating 320, means for determining 330, means for encrypting 340, and means for providing 360 may be a obtaining means, generating means, determining means, encrypting means, and providing means, respectively. The means for obtaining 310, means for generating 320, means for determining 330, means for encrypting 340, and means for providing 360 may be an obtainer, generator, determiner, encrypter, and provider, respectively. The means for obtaining 310, means for generating 320, means for determining 330, means for encrypting 340, and providing 360 may be an obtaining processor, generating processor, determining processor, encrypting processor, and providing processor, respectively.

The means for obtaining 310 obtains an effective masking parameter (S310). The means for generating 320 generates a masked weighted private key based on a private key, the effective masking parameter, and a weight (S320).

The means for determining 330 determines a vote for authenticating or authorizing a requestor (S330). The means for encrypting 340 encrypts the vote by a public key (S340). The public key used in S320 and the private key used in S340 are a public/private key pair. The means for calculating 350 calculates a value of a function of the encrypted vote and the weight (S350).

The means for providing 360 provides the masked weighted private key and the value of the function of the encrypted vote and the weight to a deciding unit for deciding whether or not to authenticate or authorize the requestor, respectively (S360).

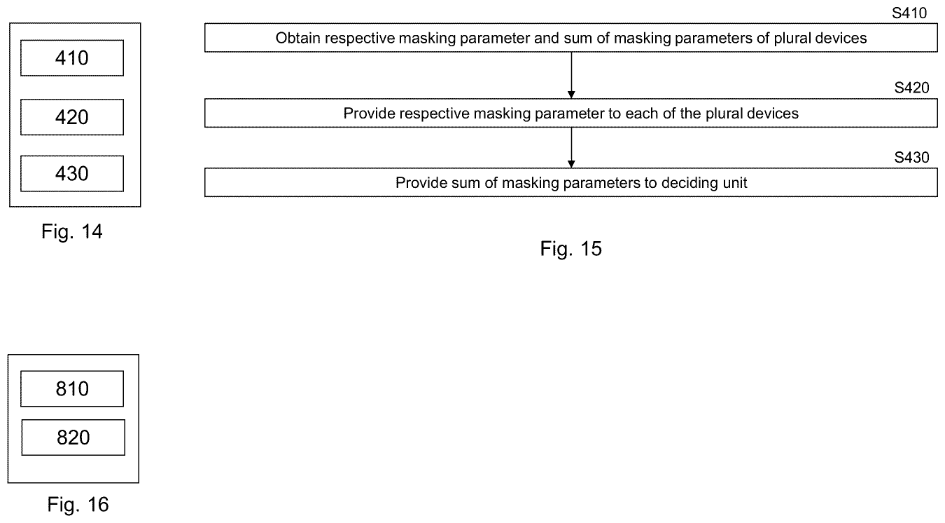

FIG. 14 shows an apparatus according to an example embodiment. The apparatus may be a master device or an element thereof. FIG. 15 shows a method according to an example embodiment. The apparatus according to FIG. 14 may perform the method of FIG. 15 but is not limited to this method. The method of FIG. 15 may be performed by the apparatus of FIG. 14 but is not limited to being performed by this apparatus.

The apparatus comprises means for obtaining 410, first means for providing 420, and second means for providing 430. The means for obtaining 410, first means for providing 420, and second means for providing 430 may be an obtaining means, first providing means, and second providing means, respectively. The means for obtaining 410, first means for providing 420, and second means for providing 430 may be an obtainer, first provider, and second provider, respectively. The means for obtaining 410, first means for providing 420, and second means for providing 430 may be an obtaining processor, first providing processor, and second providing processor, respectively.

The means for obtaining 410 obtains, for each of plural devices, a respective masking parameter and a sum of the masking parameters of the plural devices (S410). The first means for providing 420 provides, to each of the plural devices, the respective masking parameter (S420). The second means for providing 430 provides the sum of the masking parameters to a deciding unit (S430).

FIG. 16 shows an apparatus according to an example embodiment. The apparatus comprises at least one processor 810, at least one memory 820 storing instructions that, when executed by the at least one processor 810, cause the apparatus at least to perform at least one of the methods according to FIGS. 9, 11, 13, and 15 and related description.

Some features according to some example embodiments are as follows:
1. Method for generating and storing cryptographic keys on the secure hardware or trusted element on the device.
2. Method for a user or master device to generate an unmasking parameter and split them into shares
3. Method for a user or master device to distribute the shares (as per feature 2) with all the devices participating in the voting.
4. Method for a device to generate the masking parameters independently
5. Method for a device to communicate with other devices to compute a masking parameter using the shares generated as per feature 4.
6. Method for a device to cast a vote and encrypt that with the keys generated (as per feature 1).
7. Method for a remote server to set a threshold.
8. Method for a remote server to decide the result of the voting (as per feature 6) without learning about the votes of each device separately.
9. Method for a remote server to compare the voting result (calculated as per feature 8) with the threshold (as per feature 7) and decide on authorizing any given action.

Example embodiments may be applied to arbitrary computer networks including wired communication networks or wireless communication networks, such as 3GPP networks of any generation (4G, 5G, 6G, 7G, for example).

It is preferred that each of the communications between the different entities is performed in a secure way, e.g. by tunneling and/or encrypting etc.

One piece of information may be transmitted in one or plural messages from one entity to another entity. Each of these messages may comprise further (different) pieces of information.

Names of network elements, network functions, protocols, and methods are based on current standards, or are current proposals. These names are not limiting. For example, in other versions or other technologies, the names of corresponding entities may be different or the same as in the present description.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments provide, for example, a service provider (such as a service producer) or an element thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments provide, for example, a device (such as a service requestor or service consumer) or an element thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments provide, for example, a master device (such as a service requestor or service consumer) or an element thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments. However, it should be noted that the description of the preferred example embodiments is given by way of example only and that various modifications may be made without departing from the scope of the disclosure as defined by the appended claims.

The terms “first X” and “second X” include the options that “first X” is the same as “second X” and that “first X” is different from “second X”, unless otherwise specified. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. The term “or” refers to a non-exclusive “or” unless otherwise indicated (e.g., use of “or else” or “or in the alternative”).

1. An apparatus comprising:
at least one processor and
at least one memory storing instructions that, when executed by the at least one processor, cause the apparatus at least to perform
receiving a request to authenticate or authorize a requestor;
receiving, from each of plural devices, a respective masked weighted private key and, depending on a decryption algorithm, one of a respective encrypted vote or a value of a function of the respective encrypted vote and a weight for the respective device, wherein, for each of the plural devices, the respective weighted private key is a private key of the respective device weighted with the weight for the respective device;
calculating a functional decryption key based on a sum of the masked weighted private keys;
computing a sum of weighted votes of the plural devices by the decryption algorithm using the functional decryption key and the one of the encrypted votes from the plural devices or the values of the function of the encrypted vote and the weight from the plural devices, wherein, for each of the plural devices, the respective weighted vote is the vote from the respective device weighted with the weight for the respective device;
checking if the sum of the weighted votes fulfills a comparison criterion with respect to a threshold; and
inhibiting to authenticate or authorize the requestor, respectively, if the sum of the weighted votes does not fulfill the comparison criterion with respect to the threshold.

2. The apparatus according to claim 1, wherein the apparatus is further caused to perform authenticating or authorizing the requestor, respectively, if the sum of the weighted votes fulfills the comparison criterion with respect to the threshold.

3. The apparatus according to claim 1, wherein
receiving the request comprises receiving the request to authenticate or authorize the requestor, respectively, from one of the devices or from a further device different from each of the plural devices.

4. The apparatus according to claim 1, wherein the apparatus is further caused to perform
triggering each of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is received; and
inhibiting the triggering from triggering any of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is not received.

5. The apparatus according to claim 1, wherein
the comparison criterion is fulfilled if the sum of the weighted votes is larger than or equal to the threshold; or
the comparison criterion is fulfilled if the sum of the weighted votes is smaller than or equal to the threshold.

6. The apparatus according to claim 1, wherein the apparatus is further caused to perform
receiving a value of a sum of masking parameters; wherein
calculating the functional decryption key comprises calculating the functional decryption key by adding the encrypted masked weighted private keys from the plural devices to obtain an intermediate sum and subtracting the value of the sum of the masking parameters from the intermediate sum.

7. The apparatus according to claim 6, wherein the value of the sum of the masking parameters is received from a master device, wherein the master device is one of the plural devices or the master device is not one of the plural devices.

8. The apparatus according to claim 7, wherein the apparatus is further caused to perform
triggering each of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is received; and
inhibiting the triggering from triggering any of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is not received,
wherein triggering comprises triggering the master device to provide the value of the sum of the masking parameters if the request to authenticate or authorize the requestor, respectively, is received, and
wherein inhibiting comprises inhibiting the triggering from triggering the master device to provide the value of the sum of the masking parameters if the request to authenticate or authorize the requestor, respectively, is not received.

9. The apparatus according to claim 6, wherein the value of the sum of the masking parameters is received from a user.

10. The apparatus according to claim 1, wherein
calculating the functional decryption key comprises calculating the functional decryption key by adding the encrypted masked weighted private keys from the plural devices.

11. A method comprising:
receiving a request to authenticate or authorize a requestor;
receiving, from each of plural devices, a respective masked weighted private key and, depending on a decryption algorithm, one of a respective encrypted vote or a value of a function of the respective encrypted vote and a weight for the respective device, wherein, for each of the plural devices, the respective weighted private key is a private key of the respective device weighted with the weight for the respective device;
calculating a functional decryption key based on a sum of the masked weighted private keys;
computing a sum of weighted votes of the plural devices by the decryption algorithm using the functional decryption key and the one of the encrypted votes from the plural devices or the values of the function of the encrypted vote and the weight from the plural devices, wherein, for each of the plural devices, the respective weighted vote is the vote from the respective device weighted with the weight for the respective device;
checking if the sum of the weighted votes fulfills a comparison criterion with respect to a threshold; and
inhibiting to authenticate or authorize the requestor, respectively, if the sum of the weighted votes does not fulfill the comparison criterion with respect to the threshold.

12. The method according to claim 11, further comprising
authenticating or authorizing the requestor, respectively, if the sum of the weighted votes fulfills the comparison criterion with respect to the threshold.

13. The method according to claim 11, wherein
receiving the request comprises receiving the request to authenticate or authorize the requestor, respectively, from one of the devices or from a further device different from each of the plural devices.

14. The method according to claim 11, further comprising
triggering each of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is received; and
inhibiting the triggering from triggering any of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is not received.

15. The method according to claim 11, wherein
the comparison criterion is fulfilled if the sum of the weighted votes is larger than or equal to the threshold; or
the comparison criterion is fulfilled if the sum of the weighted votes is smaller than or equal to the threshold.

16. The method according to claim 11, further comprising
receiving a value of a sum of masking parameters; wherein
calculating the functional decryption key comprises calculating the functional decryption key by adding the encrypted masked weighted private keys from the plural devices to obtain an intermediate sum and subtracting the value of the sum of the masking parameters from the intermediate sum.

17. The method according to claim 16, wherein the value of the sum of the masking parameters is received from a master device, wherein the master device is one of the plural devices or the master device is not one of the plural devices.

18. The method according to claim 17, further comprising
triggering each of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is received; and
inhibiting the triggering from triggering any of the plural devices to provide the respective masked weighted private key and, depending on the decryption algorithm, the one of the respective encrypted vote or the value of the function of the respective encrypted vote and the weight for the respective device if the request to authenticate or authorize the requestor, respectively, is not received,
wherein triggering comprises triggering the master device to provide the value of the sum of the masking parameters if the request to authenticate or authorize the requestor, respectively, is received, and
wherein inhibiting comprises inhibiting the triggering from triggering the master device to provide the value of the sum of the masking parameters if the request to authenticate or authorize the requestor, respectively, is not received.

19. The method according to claim 16, wherein the value of the sum of the masking parameters is received from a user.

20. The method according to claim 11, wherein
calculating the functional decryption key comprises calculating the functional decryption key by adding the encrypted masked weighted private keys from the plural devices.
